(19) United States
(12) Patent Application Publication
(10) Pub. No.: US 2019/0097505 A1
(43) Pub. Date: Mar. 28, 2019

(54) NEEDLE WINDING DEVICE AND NEEDLE WINDING METHOD

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/115,689

(22) Filed: Aug. 29, 2018

(30) Foreign Application Priority Data
Sep. 22, 2017 (EP) 17192737.9

(51) Int. Cl. H02K 15/085; H02K 3/50; H01F 41/082

(52) U.S. Cl. CPC H02K 15/085; H02K 15/0056; H01F 41/082; H02K 3/50

(57) ABSTRACT

A needle winding device having a first needle winder and a nozzle head with a wire outlet nozzle. The first needle winder has a first nozzle head retainer that can accommodate the nozzle head. The first needle winder is configured to supply a winding wire to the nozzle head. The needle winding device also has a second needle winder with a second nozzle head retainer that can accommodate the nozzle head.

### CROSS REFERENCE TO RELATED APPLICATIONS

This patent application claims the benefit of and priority on German patent application no. 17 192 737.9 having a filing date of 22 Sep. 2017.

### BACKGROUND OF THE INVENTION

### Technical Field

The invention relates to a needle winding device with a first needle winder with a wire outlet nozzle and a needle winding method, in which a member to be wound with a wire is wound by means of such a winding device.

### Prior Art

When winding internally grooved full laminations, the needle winding method is the only direct winding method. The wire is placed by means of a needle winding head at the top of which a wire guiding nozzle is located. From this nozzle, the wire is drawn at a 90° angle. To carry out the winding, the needle passes through the groove in a first upward motion until it exits the groove on the opposite side again. Subsequently, the lamination bundle that is fastened in a rotatable clamping is turned in accordance with the desired cording and the needle is returned to the starting side in a reverse motion. After the lamination bundle has been returned to the starting position, one winding is completely wound.

The needle winding technology is described in great detail for example in the book “Handbuch der Wickeltechnik für hocheffiziente Spulen and Motoren” (Winding Technology Manual for Highly Efficient Coils and Motors) (Hagedorn, Sell-Le-Blanc, Fleischer; Springer Verlag, Berlin 2016, p. 205) and “Handbuch Fügen, Handhaben and Montieren” (Manual for Joining, Handling, and Assembling) (Feldkamp, Schoppner, Spur (Ed.); Hanser Verlag, Munich 2014, p. 219).

A needle winder with a 90° rotary head is able to wind coil bodies, but reaches its limits when winding aids are used that do not wind a simple cord between the grooves. Especially when the needle winder passes through the coil member, the range of motion is limited in the radial direction. By using needle winders with a servo swivel head that permits a rotation of the nozzle head vertical to the main axis of the winding form, it is possible to work with winding aids even in the case of distributed windings. The situation is different on the opposite, front side. By integrating the swivel mechanism, the diameter of the needle winder increases, due to which the mobility in the radial direction decreases after the winding member has passed through. The nozzle head can be swiveled, but it cannot reach the entire free space of the front side on this side. Particularly winding aids with wire guiding grooves that are radially opened toward the outside cannot be reached by the needle winder on this side.

### BRIEF SUMMARY OF THE INVENTION

It is the task of this invention to provide a needle winding device with which the entire space in the area of the front side of the winding member can be reached so that a winding member can be automatically wound by means of a needle winder with any form of winding aid.

This task is solved on the one hand with a needle winding device with a first needle winder as well as a nozzle head with a wire outlet nozzle, whereby the first needle winder may comprise a first nozzle head retainer that is able to accommodate the nozzle head, and whereby the first needle winder is configured to supply a winding wire to the nozzle head, characterized in that the needle winding device comprises a second needle winder, which comprises a second nozzle head retainer that can accommodate the nozzle head, and on the other hand with a needle winding method in which a member to be wound, in particular a stator member, is wound with a wire, in particular with distributed windings, by a winding device of the type described above, whereby the nozzle head is passed at least once from one needle winder to the other needle winder.

It is a needle winding device with a first needle winder, a nozzle head with a wire outlet nozzle, whereby the first needle winder comprises a first nozzle head retainer that is able to accommodate the nozzle head, and whereby the first needle winder is configured to supply at least one winding wire to the nozzle head. Furthermore, the needle winding device comprises a second needle winder which comprises a second nozzle head retainer that can accommodate the nozzle head. By using two needle winders between which the nozzle head can be passed, the needle winding device has a greater range of motion that is not limited by the limitation of the free space on the inside of the member to be wound.

In a preferred embodiment, the needle winding device comprises a receiving device in which a member to be wound, in particular a stator member, can be accommodated or is accommodated, whereby the receiving device for the member to be wound is arranged between the first needle winder and the second needle winder.

By using two needle winders between which the member to be wound can be passed, the needle winding device has a greater range of motion on both front sides of the member to be wound. Each of the needle winders winds the member to be wound on the front side facing it and can use the necessary free spaces without limiting the needle winder in its range of motion that would result from the passing through of the member to be wound in conventional needle winders. Therefore, members can be wound as well that have a winding aid in which the wire guiding grooves are radially opened toward the outside.

In another preferred embodiment of the needle winding device, the first needle winder comprises a first winding arm on the free end of which the first nozzle head retainer is arranged, and/or the second needle winder comprises a second winding arm at the free end of which the second nozzle head retainer is arranged.

In a particularly preferred embodiment, the first winding arm and/or the second winding arm are dimensioned such that it/they can pass through the inside of the member to be wound, especially a stator member. This ensures that the wire can be passed through the inside of the member to be wound during the winding process. It is up to the person skilled in the art in this regard as to whether the first winding arm or the second winding arm performs this part of the winding. The possibility that both winding arms can pass through the member to be wound is preferred because it increases the flexibility of the device.

In a much preferred embodiment, the nozzle head comprises swivel bearings that can be accommodated in corresponding bearing cups of the first or second nozzle head retainer. By means of a swivel bearing, the nozzle head can be detachably connected with one of the two nozzle head retainers.

It is advantageous here if the two needle winders can be moved in such a way that the two nozzle head retainers are positioned next to each other. This arrangement allows for a direct transfer of the nozzle head from one nozzle head retainer to the other without requiring an additional, separate transfer unit.

In a much preferred embodiment, the needle winding device comprises a transfer device that facilitates the decoupling of the nozzle head from the one nozzle head retainer and the coupling of the nozzle head with the respective other nozzle head retainer. This transfer device prevents the nozzle head from being free and unsecured during the transfer, which could impair the reliability of the production process, because the transfer preferably occurs during the needle winding process. Preferably, the transfer device comprises retention projections that are configured to keep the nozzle head in the first nozzle head retainer and second retention projections that are configured to keep the nozzle head in the second nozzle head retainer. It is advantageous if the first retention projections and the second retention projections are formed as parts of a fastener of a bayonet catch type.

The task at hand is solved as well by a needle winding method in which a member to be wound, in particular a stator member, is wound with a wire, in particular with distributed windings, by a winding device of the type described above, whereby the nozzle head is passed at least once from one needle winder to the other needle winder.

Preferably, and before the nozzle head is passed from one needle winder to the other needle winder, both needle winders are moved to a transfer position in which the nozzle head retainers of both needle winders are positioned next to each other or engage with each other. The position of the two nozzle head retainers next to each other or engaged with each other ensures that the transfer of the nozzle head can be performed directly and that the nozzle head is always secured during the transfer. This facilitates in particular a transfer while the device is in operation.

In a particularly preferred method, the transfer of the nozzle head occurs inside the member to be wound. This way, the point of transfer is protected by the body to be wound. It is conceivable as well, however, that the transfer occurs at the front side of the member to be wound that faces the second needle winder, if the wire is supplied by the first needle winder. To ensure the free mobility of the second needle winder, the wire supply to the wire winding head must be located on the side of the member to be wound or the winding member, respectively, that is to be wound so that the first winding arm must pass through the inside of the member to be wound.

Such a winding device creates a needle winding method that allows for particularly good flexibility and that in particular allows winding at places that cannot be reached with a single needle winder. Furthermore, the transfer of the nozzle head can take place during the winding process so that no time is lost either.

The invention is explained below in further detail on the basis of an exemplary embodiment.

### BRIEF DESCRIPTION OF THE DRAWINGS

FIG. 1 shows a side view of a needle winding device according to the invention;

FIG. 2 shows two winding arms in which the nozzle head retainers face each other at a distance, with a nozzle head from a side view shown between them;

FIG. 3 shows a sectional view of two winding arms that face each other whose profile is on a plane that is vertical to the plane of projection of FIG. 2;

FIGS. 4 to 6 show three stages of a transfer process; and

FIG. 7 shows different winding situations.

### DETAILED DESCRIPTION OF PREFERRED EMBODIMENTS

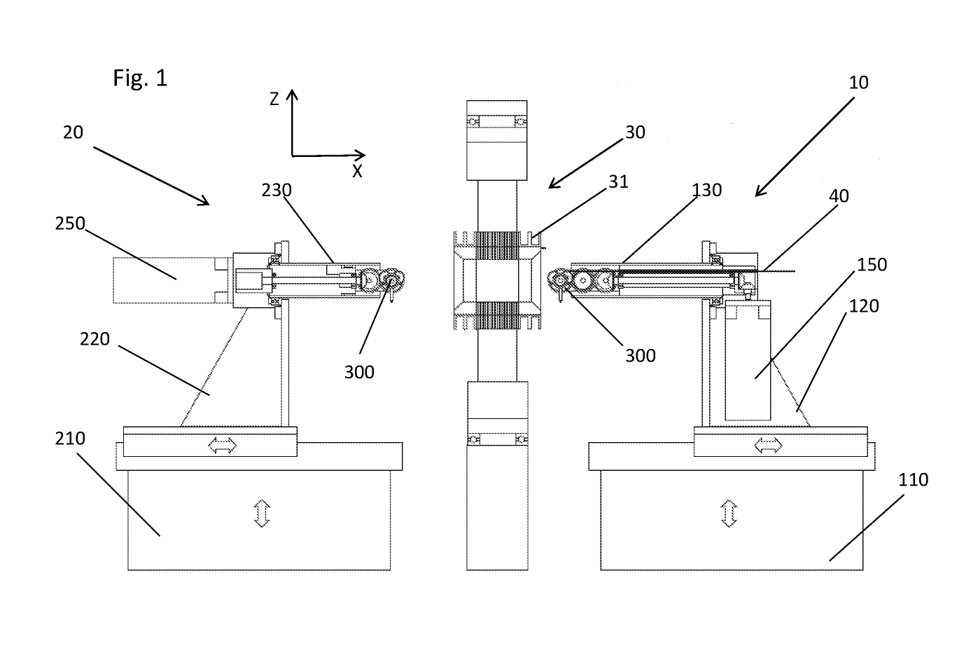

FIG. 1 shows a needle winding device with two needle winders 10, 20, between which a member 31 to be wound is arranged that is mounted in a receiving device 30. The receiving device 30 is preferably a turning device and retains the member 31 to be wound by means of a clamping device, for example a three-jaw chuck. Other receiving devices may be used as well, however. The winding arm 130, 230 is mounted in this embodiment to a horizontal sliding carriage 120, 220, which, in turn, is mounted to a vertical sliding carriage 110, 210. Furthermore, each needle winder 10, 20 is equipped with a drive 150, 250 to swivel the nozzle head 300. The one needle winder 10 (shown on the right in the example) is furthermore equipped with the guide of a winding wire 40. The figure shows one nozzle head 300 at the free end of each winding arm 130, 230. The needle winding device is, however, configured so that it can perform the needle winding method with a single nozzle head 300.

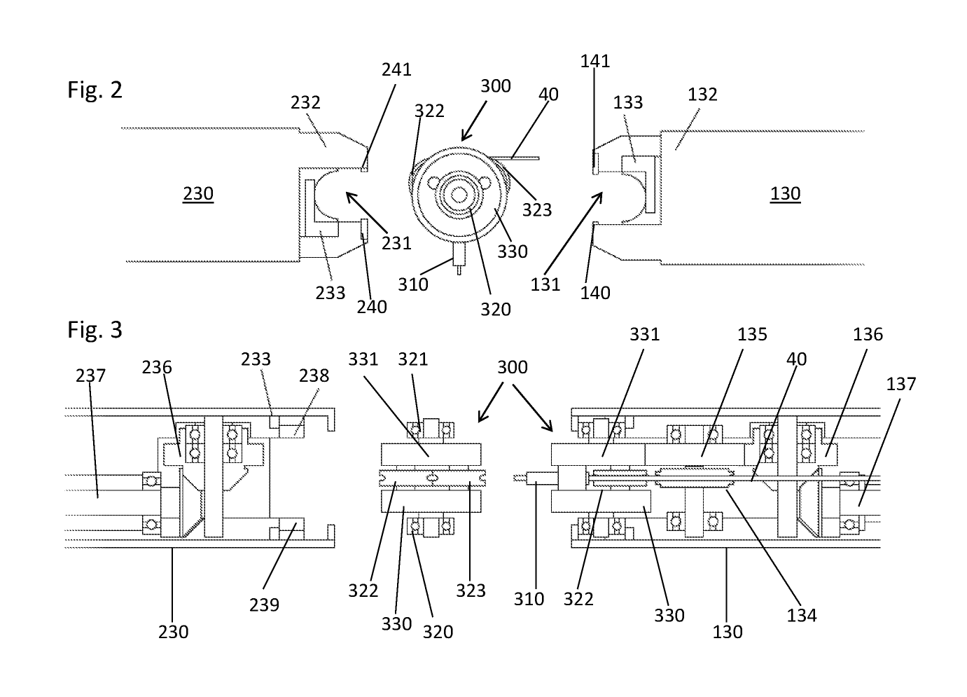

FIG. 2 shows two winding arms 130, 230 in which the nozzle head retainers 131, 231 face each other. Each winding arm 130, 230 is sheathed by a switching element, in the preferred example shown by a switching sheath 132, 232, with which the bayonet catch 140, 141, 240, 241 shown here can be opened or locked by turning the switching element 132, 232. The locking device is formed by the retention projections 140, 141 or 240, 241 respectively. A release 133, 233 is integrated in the posterior part of the nozzle retainer 131, 231 which abuts against the retention projections 140, 141 or respectively 240, 241 of the opposing bayonet catch during the transfer and jointly turns the locking devices. The drive of the switching elements 132, 232 is discretionary. A pneumatic rotary drive is preferred. The drive may, however, be electric, hydraulic, or magnetic as well. The locking devices shown here are both open in the drawing; the retention projections 140, 141, 240, 241 do not retain the nozzle head 300.

The nozzle head 300, which is supplied with the winding wire 40 from the right (only indicated), is shown between the winding arms 130, 230. This winding wire 40 is supplied from the guide rollers 322, 323 of the wire outlet nozzle 310. The nozzle head 300 is furthermore provided with swivel bearings 320, 321, of which only one is shown in the view provided. Two angle-adjusting wheels 330, 331 are arranged between the swivel bearings, between which the guide rollers 322, 323 (over which the wire 40 is guided) and the wire outlet nozzle 310, from which the wire 40 is provided, are arranged.

FIG. 3 shows a sectional view through the winding arms 130, 230, whereby the perspective is turned by 90° from the view in FIG. 2. The right winding arm 130 is shown on the right. In this illustration, a nozzle head 300 is arranged on the winding arm 130. The head 300 is adjusted by a swivel drive 150 (not shown here). By means of, preferably two, angle gears, the movement of the drive shaft 137 is transferred to a front gear 136. This rotary motion is transferred to the angle-setting wheel 331 that adjusts the wire outlet nozzle 310. A guide roller 134 is positioned separately on the axle on which the interim gear 135 is positioned. By means of this guide roller, the winding wire 40 is guided to the guide rollers 322, 323 of the nozzle head 300 and passed from there through the wire outlet nozzle 310.

FIG. 3 shows in its center a nozzle head 300 in which the wire outlet nozzle 310 points into the plane of projection. The two guide rollers 322, 323 are arranged between two angle-setting wheels 330, 331. The two swivel gears 322, 323 are arranged on the outside of the angle-setting wheels 320, 321.

The second winding arm 230 is shown in the drawing on the left side. The movement of the actuating drive 250 (not shown here) is transferred via the drive shaft 237 and, preferably two, angle gears to the front gear 236. If now the nozzle head 300 is inserted into the nozzle head retainer 231 in such a way that the swivel bearings 320, 321 rest in the bearing cups 238, 239, the angle-setting wheel 331 comes in contact with the front gear 236 and can execute the swivel movements of the drive.

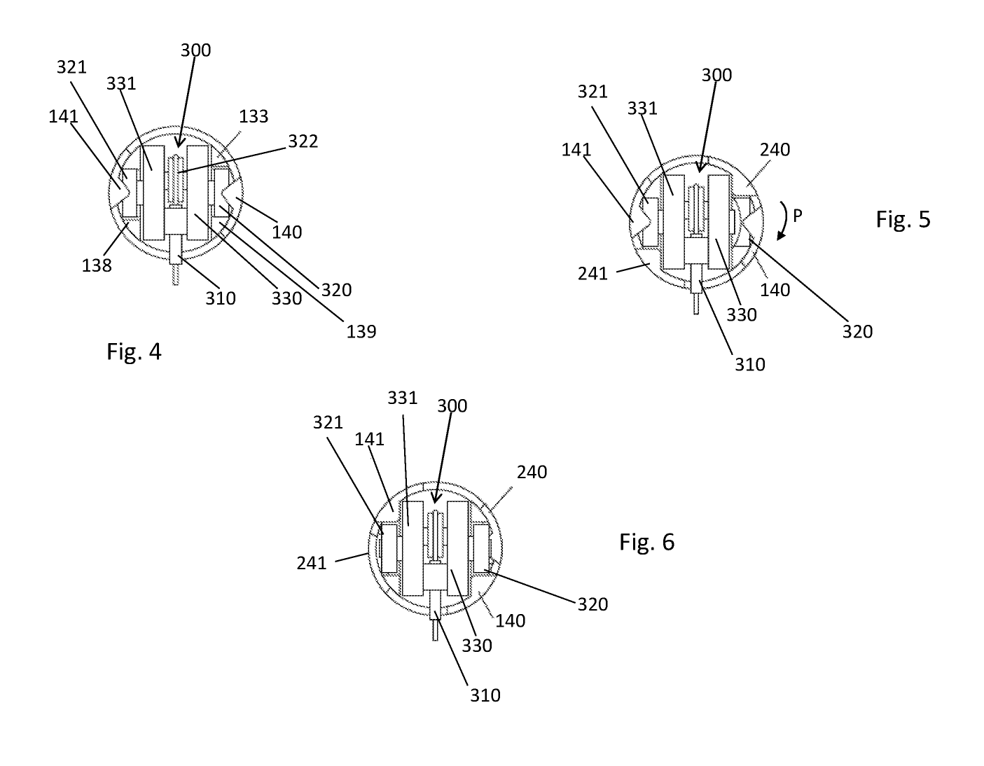

A transfer is described in FIGS. 4 to 6. This transfer is shown from the second nozzle head retainer perspective. The starting situation in FIG. 4 is a nozzle head 300 that is fastened to the first winding arm 10. The swivel bearings 320, 321 are positioned in the back on the bearing cups 138, 139 and fastened in the forward direction with the retention projections 140, 141. The release 133 is arranged above the retention projection 140 behind the swivel bearing 320.

FIG. 5 shows how the two winding arms 130, 230 are joined. The illustration shows the two retention projections 240, 241 of the second winding arm 230; the one retention projection 241 passes below the retention projection 141; the other retention projection 240 passes above the retention projection 140. The retention projections 240, 241 pass the nozzle head 300 until they have arrived at a plane directly below the swivel bearings 320, 321. Here, the two bearing cups 238, 239 abut against the front of the swivel bearings 320, 321 (not shown). The switching sheaths 132, 232 rotate the retention projections 140, 141, 240, 241 in the clockwise direction P. As a result, the retention projections 140, 141 release the swivel bearings 320, 321 and the retention projections 240, 241 fasten the swivel bearings 320, 321 from the back as shown in FIG. 6. When the two winding arms 130, 230 move away from each other, the first winding arm 130 releases the nozzle head 300 and the second winding arm 230 retains it.

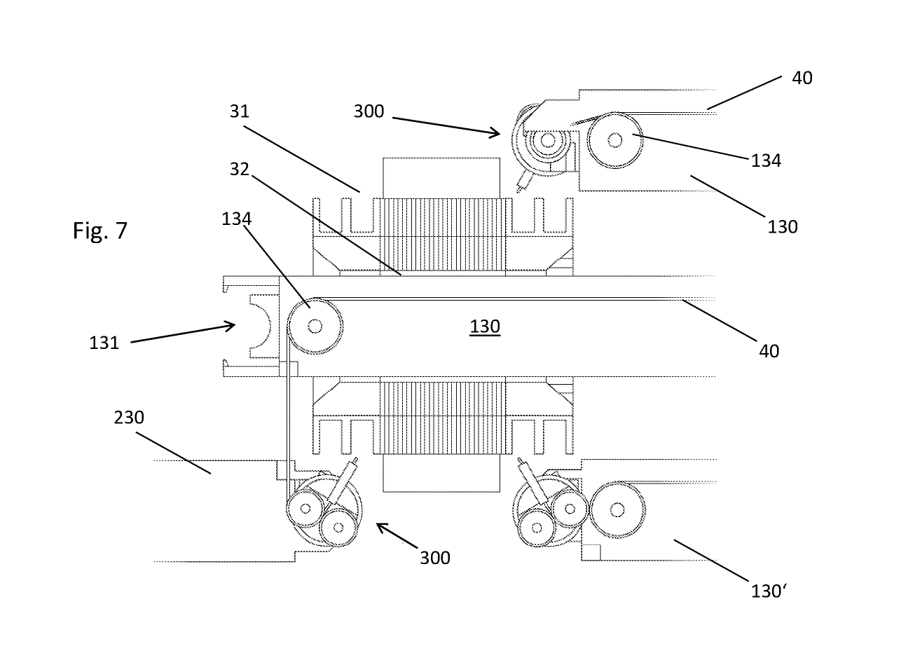

FIG. 7 shows three winding situations. On the top right, it shows a winding arm 130 in which the winding wire 40 is supplied to the nozzle head 300 by means of a guide roller 134. The wire 40 (not shown) is placed for example in a radial wire guiding groove that is opened to the outside and that is part of a winding aid placed on the member 31 to be wound. On the bottom right, the same situation is shown on the other side of the member. The left shows a situation in which the nozzle head 300 has been transferred to the second winding arm 230. The first winding arm 130 has passed through the inside 32 of the member 31 to be wound far enough so that the winding wire 40 coming from the guide roller 134 freely passes to the guide rollers 322, 323 of the nozzle head 300.

Since the winding arm 130 no longer has to span the member 31 to be wound through the inside 32, because the nozzle head 300 is simply transferred to the second winding arm 230, the configuration of the individual winding arm 130, 230 can have a simpler design and can therefore be built with a smaller width. With an outer diameter of the winding arm 130, 230 of no more than 45 mm, a stator 31 with an inner diameter of at least 50 mm can be wound with a winding wire 40 up to 1 mm thick. The design of the needle winding device can be more filigreed also, which applies to smaller inner diameters of stators as well. It is possible as well to make the design more stable and larger to wind larger stators.

What is claimed is:

1. A needle winding device with a first needle winder (10) and a nozzle head (300) with a wire outlet nozzle (310), whereby the first needle winder (10) may comprise a first nozzle head retainer (131) that is able to accommodate the nozzle head, and whereby the first needle winder (10) is configured to supply a winding wire (40) to the nozzle head (300),
wherein
the needle winding device comprises a second needle winder (20), which comprises a second nozzle head retainer (231) that can accommodate the nozzle head (300).

2. The needle winding device according to claim 1,
further comprising a receiving device (30) in which a member (31) to be wound, in particular a stator member, can be accommodated or is accommodated, whereby the receiving device (30) for the member (31) to be wound is arranged between the first needle winder (10) and the second needle winder (20).

3. The needle winding device according to claim 1,
wherein
the first needle winder (10) comprises a first winding arm (130) on the free end of which the first nozzle head retainer (131) is arranged, and/or the second needle winder (20) comprises a second winding arm (230) at the free end of which the second nozzle head retainer (231) is arranged.

4. The needle winding device according to claim 3,
wherein
the first winding arm (130) and/or the second winding arm (230) are dimensioned such that it/they can pass through the inside (32) of the member (30) to be wound, especially a stator member.

5. The needle winding device according to claim 1,
wherein
the nozzle head (300) comprises swivel bearings (320, 321) that can be accommodated in the corresponding bearing cups (138, 139; 238, 239) of the first or second nozzle head retainer (131; 231).

6. The needle winding device according to claim 1,
wherein
the two needle winders (10, 20) can be moved in such a way that the two nozzle head retainers (131, 231) are positioned next to each other.

7. The needle winding device according to claim 1,
wherein
the needle winding device further comprises a transfer device (140, 141; 240, 241) that facilitates the decoupling of the nozzle head (300) from the one nozzle head retainer (131) and the coupling of the nozzle head (300) with the respective other nozzle head retainer (231).

8. The needle winding device according to claim 7,
wherein
the transfer device (140, 141; 240, 241) comprises retention projections (140, 141) that are configured to keep the nozzle head (300) in the first nozzle head retainer (131) and second retention projections (240, 241) that are configured to keep the nozzle head (300) in the second nozzle head retainer (231).

9. The needle winding device according to claim 8,
wherein
the first retention projections (140, 141) and the second retention projections (240, 241) are formed as parts of a fastener of a bayonet catch type.

10. A needle winding method in which a member (31) to be wound, in particular a stator member, is wound with a wire (40), in particular with distributed windings, by a winding device of the type described above, comprising passing a nozzle head (300) at least once from a first needle winder (10) to a second needle winder (20).

11. The needle winding method according to claim 10,
further comprising
before passing the nozzle head from the first needle winder (10) to the second needle winder (20), moving both needle winders (10, 20) to a transfer position in which the nozzle head retainers (131, 231) of both needle winders (10, 20) are positioned next to each other or engage with each other.

12. The needle winding method according to claim 11,
wherein
the transfer of the nozzle head (300) occurs inside (32) the member (31) to be wound.
